(19) United States
(12) Patent Application Publication
(10) Pub. No.: US 2026/0261427 A1
(43) Pub. Date: Sep. 3, 2026

(54) SYSTEM AND A METHOD TO DETECT AND PREVENT TAMPERING IN USER-ARTIFICIAL INTELLIGENCE CONVERSATIONS

(71) Applicant: Securiti, Inc, San Jose, CA (US)

(72) Inventor: Michael D. Rinehart, Pleasanton, CA (US)

(21) Appl. No.: 19/554,947

(22) Filed: Mar. 3, 2026

Related U.S. Application Data
(60) Provisional application No. 63/765,776, filed on Mar. 3, 2025.

(51) Int. Cl. H04L 9/32; H04L 9/00; H04L 9/08; H04L 51/02; H04L 51/216

(52) U.S. Cl. CPC H04L 9/3242; H04L 9/0869; H04L 9/50; H04L 51/02; H04L 51/216

(57) ABSTRACT

A system and a method to detect and prevent tampering in user-artificial intelligence conversations is provided. The system includes a hardware processor and a memory to store instructions hosted on server over network controlling communications. A guardrail module receives prompt from user operating user device, determines policy violation, and replaces prompt with null value upon violation. A hash module includes proof-of-knowledge hash function, generates high-entropy secret using secure random number generator, stores secret in database, and applies secure hash salted with secret to generate message hash and chain hash for each conversation entry in block-chained history. A blockchain management module records entries, appends entry, maintains continuity, and truncates history. A verification module verifies integrity and identifies tampering. An update module processes prompt, generates response, computes hashes, and appends entry. A compression module generates summary and recomputes hashes preserving integrity.

### EARLIEST PRIORITY DATE

This application claims priority from a Provisional patent application filed in the United States of America having Patent Application No. 63/765,777, filed on Mar. 3, 2025, and titled “DETECTING USER-AI CONVERSATION TAMPERING TO SAFEGUARD AI SYSTEMS”.

### FIELD OF INVENTION

Embodiments of the present disclosure relate to a field of distributed computing systems and secure conversational data integrity management and more particularly to a system and a method to detect and prevent tampering in user-artificial intelligence conversations.

### BACKGROUND

Artificial intelligence systems, particularly conversational artificial intelligence models deployed over networked environments, have become widely integrated into enterprise platforms, consumer applications, and automated decision-support systems. Such systems typically maintain conversational context across multiple interactions between a user operating a user device and a server hosting the artificial intelligence model. Conversation history is often transmitted alongside a new prompt to preserve contextual continuity and improve response accuracy. In many deployments, conversation history is stored in application memory, persistent databases, or distributed storage systems and is reused for subsequent inference operations.

Conventional conversational systems frequently implement guardrail mechanisms to detect policy violations, malicious inputs, restricted content, or non-compliant requests. Guardrail enforcement may block a prompt, modify a prompt, or replace a prompt prior to submission to an artificial intelligence model. However, many implementations rely on client-provided conversation history without cryptographic validation, thereby creating vulnerability to manipulation of stored conversation entries. An attacker may inject fabricated prior prompts, alter stored responses, or replay modified conversation sequences in order to influence subsequent artificial intelligence model outputs. Such manipulation may bypass prompt-level guardrail checks because malicious content can be embedded within conversation history rather than within a current prompt.

Existing approaches for protecting conversation integrity often involve reassessing entire conversation history at each interaction, performing extensive policy re-evaluation, or limiting conversation length to reduce risk exposure. These approaches may introduce significant computational overhead, increase latency, reduce scalability, and degrade user experience. Additionally, many systems lack deterministic tamper-evident mechanisms capable of detecting selective modification, deletion, insertion, or reordering of individual conversation entries.

Hence, there is a need for an improved system and method to detect and prevent tampering in user-artificial intelligence conversations that addresses the aforementioned issue(s).

### OBJECTIVE OF THE INVENTION

A primary objective of the invention is to provide a system and a method configured to detect and prevent tampering in user-artificial intelligence conversations by maintaining a cryptographically secured block-chained conversation history that ensures ordered continuity and tamper-evident integrity across a plurality of conversation entries.

Another objective of the invention is to provide a proof-of-knowledge hashing mechanism incorporating a high-entropy server-side secret to enable exclusive generation and verification of a message hash and a chain hash within a trusted server environment, thereby preventing unauthorized re-computation or manipulation of conversation data.

Yet another objective of the invention is to enable enforcement of policy compliance within user-artificial intelligence conversations through controlled evaluation of a prompt and deterministic replacement of a prompt with a null value upon identification of a policy violation, while preserving structural continuity of the block-chained conversation history.

Yet another objective of the invention is to provide efficient scalability and context management through implementation of a sliding window mechanism, selective truncation, and controlled compression of at least one portion of the block-chained conversation history, while preserving cryptographic linkage and integrity verification in both stateful service architecture and stateless service architecture.

### BRIEF DESCRIPTION

In accordance with an embodiment of the present disclosure, a system to detect and prevent tampering in user-artificial intelligence conversations is provided. The system includes a hardware processor, and a memory coupled to the hardware processor. The memory comprises a set of program instructions in the form of a processing subsystem hosted on a server and configured to execute on a network to control bidirectional communications among a plurality of modules. The processing subsystem includes a guardrail module. The guardrail module configured to receive a prompt to initiate a user-artificial intelligence conversation from the user operating a user device and determine whether the prompt comprises a policy violation. The guardrail module configured to replace the prompt with a null value upon determination of the policy violation. The processing subsystem includes a hash module operatively coupled to the guardrail module. The hash module comprises a proof-of-knowledge hash function. The hash module is configured to generate a high-entropy server-side secret using a cryptographically secure random number generator and store the high-entropy server-side secret in a database. The hash module is configured to apply a secure hash function salted with the server-side secret to generate a message hash and a chain hash corresponding to each of a plurality of conversation entries of a block-chained conversation history. The hash module is configured to assign a predefined zero value as the message hash when a prompt corresponding to a conversation entry of the plurality of conversation entries is the null value. The processing subsystem includes a blockchain management module operatively coupled to the hash module. The blockchain management module is configured to record the plurality of conversation entries on a blockchain to generate the block-chained conversation history, wherein each of the plurality of conversation entries comprises the prompt corresponding to the conversation entry, a response generated by an artificial intelligence model corresponding to the conversation entry, the message hash corresponding to the conversation entry, and the chain hash corresponding to the conversation entry. The blockchain management module is configured to append a new conversation entry corresponding to a new prompt to the plurality of conversation entries of the block-chained conversation history based on the message hash and the chain hash corresponding to the new conversation entry. The blockchain management module is configured to maintain continuity of the block-chained conversation history by linking the chain hash corresponding to each conversation entry of the plurality of conversation entries to a preceding chain hash corresponding to a prior conversation entry of the plurality of conversation entries. The blockchain management module is configured to truncate the block-chained conversation history backwards in time using a sliding window mechanism specifically tailored for blockchain-based artificial intelligence model conversation history. The blockchain management module is configured to remove one or more prompts that were replaced with the null value and store the one or more prompts as the null value within the plurality of conversation entries. The blockchain management module is configured to treat the new prompt as a continuation of the block-chained conversation history from a point at which the block-chained conversation history was previously truncated based on an edit made to an earlier prompt. The processing subsystem includes a verification module operatively coupled to the blockchain management module and the hash module. The verification module is configured to verify integrity of the block-chained conversation history prior to processing the new prompt by recomputing the message hash corresponding to each conversation entry of the plurality of conversation entries and the chain hash corresponding to each conversation entry of the plurality of conversation entries. The verification module is configured to verify correctness of the chain hash corresponding to each conversation entry of the plurality of conversation entries to ensure continuity of the block-chained conversation history remains unbroken. The verification module is configured to detect one or more discrepancies between a recomputed message hash corresponding to a conversation entry of the plurality of conversation entries or a recomputed chain hash corresponding to a conversation entry of the plurality of conversation entries and a corresponding stored message hash or a corresponding stored chain hash of the block-chained conversation history. The verification module is configured to identify a tampering of the block-chained conversation history upon detection of the one or more discrepancies. The processing subsystem includes an update module operatively coupled to the guardrail module, the verification module, and the blockchain management module. The update module is configured to process the new prompt upon successful verification of the block-chained conversation history to determine whether the new prompt comprises a policy violation and replace the new prompt with the null value when the new prompt comprises the policy violation. generate a response corresponding to the new prompt using the artificial intelligence model. The update module is configured to compute the message hash corresponding to a new conversation entry and the chain hash corresponding to the new conversation entry. The update module is configured to update the block-chained conversation history by appending the new conversation entry to the plurality of conversation entries, wherein the new conversation entry comprising the new prompt, the response, the message hash, and the chain hash. The processing subsystem includes a compression module operatively coupled to the blockchain management module. The compression module is configured to generate a compressed conversation summary based on at least one portion of the block-chained conversation history. The compression module is configured to recompute the message hash corresponding to the compressed conversation summary and the chain hash to preserve an integrity of the block-chained conversation history.

In accordance with another embodiment of the present disclosure, a method to detect and prevent tampering in user-artificial intelligence conversations is provided. The method includes receiving a plurality of raw delimited text files from one or more unstructured sources from a user operating a user device. The method includes receiving, a prompt to initiate a user-artificial intelligence conversation from a user and determine whether the prompt comprises a policy violation. The method includes replacing the prompt with a null value upon determination of the policy violation. The method includes generating a high-entropy server-side secret using a cryptographically secure random number generator and storing the high-entropy server-side secret in a database. The method includes applying a secure hash function salted with the server-side secret to generate a message hash and a chain hash corresponding to each of a plurality of conversation entries of a block-chained conversation history. The method includes assigning a predefined zero value as the message hash when a prompt corresponding to a conversation entry of the plurality of conversation entries is the null value. The method includes recording the plurality of conversation entries on a blockchain to generate the block-chained conversation history, wherein each of the plurality of conversation entries comprises the prompt corresponding to the conversation entry, a response generated by an artificial intelligence model corresponding to the conversation entry, the message hash corresponding to the conversation entry, and the chain hash corresponding to the conversation entry. The method includes appending a new conversation entry corresponding to a new prompt to the plurality of conversation entries of the block-chained conversation history based on the message hash and the chain hash corresponding to the new conversation entry. The method includes maintaining continuity of the block-chained conversation history by linking the chain hash corresponding to each conversation entry of the plurality of conversation entries to a preceding chain hash corresponding to a prior conversation entry of the plurality of conversation entries. The method includes truncating the block-chained conversation history backwards in time using a sliding window mechanism specifically tailored for blockchain-based artificial intelligence model conversation history. The method includes removing one or more prompts that were replaced with the null value and storing the one or more prompts as the null value within the plurality of conversation entries. The method includes treating the new prompt as a continuation of the block-chained conversation history from a point at which the block-chained conversation history was previously truncated based on an edit made to an earlier prompt. The method includes verifying integrity of the block-chained conversation history prior to processing the new prompt by recomputing the message hash corresponding to each conversation entry of the plurality of conversation entries and the chain hash corresponding to each conversation entry of the plurality of conversation entries. The method includes verifying correctness of the chain hash corresponding to each conversation entry of the plurality of conversation entries to ensure continuity of the block-chained conversation history remains unbroken. The method includes detecting one or more discrepancies between a recomputed message hash corresponding to a conversation entry of the plurality of conversation entries or a recomputed chain hash corresponding to a conversation entry of the plurality of conversation entries and a corresponding stored message hash or a corresponding stored chain hash of the block-chained conversation history. The method includes identifying a tampering of the block-chained conversation history upon detection of the one or more discrepancies. The method includes processing the new prompt upon successful verification of the block-chained conversation history to determine whether the new prompt comprises a policy violation and replacing the new prompt with the null value when the new prompt comprises the policy violation. The method includes generating a response corresponding to the new prompt using the artificial intelligence model. The method includes computing the message hash corresponding to a new conversation entry and the chain hash corresponding to the new conversation entry. The method includes updating the block-chained conversation history by appending the new conversation entry to the plurality of conversation entries, wherein the new conversation entry comprises the new prompt, the response, the message hash, and the chain hash. The method includes generating a compressed conversation summary based on at least one portion of the block-chained conversation history. The method includes recomputing the message hash corresponding to the compressed conversation summary and the chain hash corresponding to the compressed conversation summary to preserve integrity of the block-chained conversation history.

In accordance with another embodiment of the present disclosure, a non-transitory computer-readable medium storing a computer program that, when executed by a processor, causes the processor to perform a method to detect and prevent tampering in user-artificial intelligence conversations is provided. The method includes receiving a plurality of raw delimited text files from one or more unstructured sources from a user operating a user device. The method includes receiving, a prompt to initiate a user-artificial intelligence conversation from a user and determine whether the prompt comprises a policy violation. The method includes replacing the prompt with a null value upon determination of the policy violation. The method includes generating a high-entropy server-side secret using a cryptographically secure random number generator and storing the high-entropy server-side secret in a database. The method includes applying a secure hash function salted with the server-side secret to generate a message hash and a chain hash corresponding to each of a plurality of conversation entries of a block-chained conversation history. The method includes assigning a predefined zero value as the message hash when a prompt corresponding to a conversation entry of the plurality of conversation entries is the null value. The method includes recording the plurality of conversation entries on a blockchain to generate the block-chained conversation history, wherein each of the plurality of conversation entries comprises the prompt corresponding to the conversation entry, a response generated by an artificial intelligence model corresponding to the conversation entry, the message hash corresponding to the conversation entry, and the chain hash corresponding to the conversation entry. The method includes appending a new conversation entry corresponding to a new prompt to the plurality of conversation entries of the block-chained conversation history based on the message hash and the chain hash corresponding to the new conversation entry. The method includes maintaining continuity of the block-chained conversation history by linking the chain hash corresponding to each conversation entry of the plurality of conversation entries to a preceding chain hash corresponding to a prior conversation entry of the plurality of conversation entries. The method includes truncating the block-chained conversation history backwards in time using a sliding window mechanism specifically tailored for blockchain-based artificial intelligence model conversation history. The method includes removing one or more prompts that were replaced with the null value and storing the one or more prompts as the null value within the plurality of conversation entries. The method includes treating the new prompt as a continuation of the block-chained conversation history from a point at which the block-chained conversation history was previously truncated based on an edit made to an earlier prompt. The method includes verifying integrity of the block-chained conversation history prior to processing the new prompt by recomputing the message hash corresponding to each conversation entry of the plurality of conversation entries and the chain hash corresponding to each conversation entry of the plurality of conversation entries. The method includes verifying correctness of the chain hash corresponding to each conversation entry of the plurality of conversation entries to ensure continuity of the block-chained conversation history remains unbroken. The method includes detecting one or more discrepancies between a recomputed message hash corresponding to a conversation entry of the plurality of conversation entries or a recomputed chain hash corresponding to a conversation entry of the plurality of conversation entries and a corresponding stored message hash or a corresponding stored chain hash of the block-chained conversation history. The method includes identifying a tampering of the block-chained conversation history upon detection of the one or more discrepancies. The method includes processing the new prompt upon successful verification of the block-chained conversation history to determine whether the new prompt comprises a policy violation and replacing the new prompt with the null value when the new prompt comprises the policy violation. The method includes generating a response corresponding to the new prompt using the artificial intelligence model. The method includes computing the message hash corresponding to a new conversation entry and the chain hash corresponding to the new conversation entry. The method includes updating the block-chained conversation history by appending the new conversation entry to the plurality of conversation entries, wherein the new conversation entry comprises the new prompt, the response, the message hash, and the chain hash. The method includes generating a compressed conversation summary based on at least one portion of the block-chained conversation history. The method includes recomputing the message hash corresponding to the compressed conversation summary and the chain hash corresponding to the compressed conversation summary to preserve integrity of the block-chained conversation history.

To further clarify the advantages and features of the present disclosure, a more particular description of the disclosure will follow by reference to specific embodiments thereof, which are illustrated in the appended figures. It is to be appreciated that these figures depict only typical embodiments of the disclosure and are therefore not to be considered limiting in scope. The disclosure will be described and explained with additional specificity and detail with the appended figures.

### BRIEF DESCRIPTION OF THE DRAWINGS

The disclosure will be described and explained with additional specificity and detail with the accompanying figures in which:

FIG. 1 is a block diagram representation of a system to detect and prevent tampering in user-artificial intelligence conversations in accordance with an embodiment of the present disclosure;

FIG. 2 is a block diagram of a computer or a server in accordance with an embodiment of the present disclosure;

FIG. 3a is a flow chart representing the steps involved in a method to detect and prevent tampering in user-artificial intelligence conversations in accordance with an embodiment of the present disclosure;

FIG. 3b is a flow chart representing the continued steps involved in a method of FIG. 3a, in accordance with an embodiment of the present disclosure; and

FIG. 3c is a flow chart representing the continued steps involved in a method of FIG. 3b, in accordance with an embodiment of the present disclosure.

Further, those skilled in the art will appreciate that elements in the figures are illustrated for simplicity and may not have necessarily been drawn to scale. Furthermore, in terms of the construction of the device, one or more components of the device may have been represented in the figures by conventional symbols, and the figures may show only those specific details that are pertinent to understanding the embodiments of the present disclosure so as not to obscure the figures with details that will be readily apparent to those skilled in the art having the benefit of the description herein.

### DETAILED DESCRIPTION

For the purpose of promoting an understanding of the principles of the disclosure, reference will now be made to the embodiment illustrated in the figures and specific language will be used to describe them. It will nevertheless be understood that no limitation of the scope of the disclosure is thereby intended. Such alterations and further modifications in the illustrated system, and such further applications of the principles of the disclosure as would normally occur to those skilled in the art are to be construed as being within the scope of the present disclosure.

The terms “comprises”, “comprising”, or any other variations thereof, are intended to cover a non-exclusive inclusion, such that a process or method that comprises a list of steps does not include only those steps but may include other steps not expressly listed or inherent to such a process or method. Similarly, one or more devices or sub-systems or elements or structures or components preceded by “comprises . . . a” does not, without more constraints, preclude the existence of other devices, sub-systems, elements, structures, components, additional devices, additional sub-systems, additional elements, additional structures, or additional components. Appearances of the phrase “in an embodiment”, “in another embodiment” and similar language throughout this specification may, but not necessarily do, all refer to the same embodiment.

Unless otherwise defined, all technical and scientific terms used herein have the same meaning as commonly understood by those skilled in the art to which this disclosure belongs. The system, methods, and examples provided herein are only illustrative and not intended to be limiting.

In the following specification and the claims, reference will be made to a number of terms, which shall be defined to have the following meanings. The singular forms “a”, “an”, and “the” include plural references unless the context clearly dictates otherwise.

Embodiments of the present disclosure relate to a system and a method to detect and prevent tampering in user-artificial intelligence conversations. The system includes a hardware processor, and a memory coupled to the hardware processor. The memory comprises a set of program instructions in the form of a processing subsystem hosted on a server and configured to execute on a network to control bidirectional communications among a plurality of modules. The processing subsystem includes a guardrail module. The guardrail module configured to receive a prompt to initiate a user-artificial intelligence conversation from the user operating a user device and determine whether the prompt comprises a policy violation. The guardrail module configured to replace the prompt with a null value upon determination of the policy violation. The processing subsystem includes a hash module operatively coupled to the guardrail module. The hash module comprises a proof-of-knowledge hash function. The hash module is configured to generate a high-entropy server-side secret using a cryptographically secure random number generator and store the high-entropy server-side secret in a database. The hash module is configured to apply a secure hash function salted with the server-side secret to generate a message hash and a chain hash corresponding to each of a plurality of conversation entries of a block-chained conversation history. The hash module is configured to assign a predefined zero value as the message hash when a prompt corresponding to a conversation entry of the plurality of conversation entries is the null value. The processing subsystem includes a blockchain management module operatively coupled to the hash module. The blockchain management module is configured to record the plurality of conversation entries on a blockchain to generate the block-chained conversation history, wherein each of the plurality of conversation entries comprises the prompt corresponding to the conversation entry, a response generated by an artificial intelligence model corresponding to the conversation entry, the message hash corresponding to the conversation entry, and the chain hash corresponding to the conversation entry. The blockchain management module is configured to append a new conversation entry corresponding to a new prompt to the plurality of conversation entries of the block-chained conversation history based on the message hash and the chain hash corresponding to the new conversation entry. The blockchain management module is configured to maintain continuity of the block-chained conversation history by linking the chain hash corresponding to each conversation entry of the plurality of conversation entries to a preceding chain hash corresponding to a prior conversation entry of the plurality of conversation entries. The blockchain management module is configured to truncate the block-chained conversation history backwards in time using a sliding window mechanism specifically tailored for blockchain-based artificial intelligence model conversation history. The blockchain management module is configured to remove one or more prompts that were replaced with the null value and store the one or more prompts as the null value within the plurality of conversation entries. The blockchain management module is configured to treat the new prompt as a continuation of the block-chained conversation history from a point at which the block-chained conversation history was previously truncated based on an edit made to an earlier prompt. The processing subsystem includes a verification module operatively coupled to the blockchain management module and the hash module. The verification module is configured to verify integrity of the block-chained conversation history prior to processing the new prompt by recomputing the message hash corresponding to each conversation entry of the plurality of conversation entries and the chain hash corresponding to each conversation entry of the plurality of conversation entries. The verification module is configured to verify correctness of the chain hash corresponding to each conversation entry of the plurality of conversation entries to ensure continuity of the block-chained conversation history remains unbroken. The verification module is configured to detect one or more discrepancies between a recomputed message hash corresponding to a conversation entry of the plurality of conversation entries or a recomputed chain hash corresponding to a conversation entry of the plurality of conversation entries and a corresponding stored message hash or a corresponding stored chain hash of the block-chained conversation history. The verification module is configured to identify a tampering of the block-chained conversation history upon detection of the one or more discrepancies. The processing subsystem includes an update module operatively coupled to the guardrail module, the verification module, and the blockchain management module. The update module is configured to process the new prompt upon successful verification of the block-chained conversation history to determine whether the new prompt comprises a policy violation and replace the new prompt with the null value when the new prompt comprises the policy violation. generate a response corresponding to the new prompt using the artificial intelligence model. The update module is configured to compute the message hash corresponding to a new conversation entry and the chain hash corresponding to the new conversation entry. The update module is configured to update the block-chained conversation history by appending the new conversation entry to the plurality of conversation entries, wherein the new conversation entry comprising the new prompt, the response, the message hash, and the chain hash. The processing subsystem includes a compression module operatively coupled to the blockchain management module. The compression module is configured to generate a compressed conversation summary based on at least one portion of the block-chained conversation history. The compression module is configured to recompute the message hash corresponding to the compressed conversation summary and the chain hash to preserve an integrity of the block-chained conversation history.

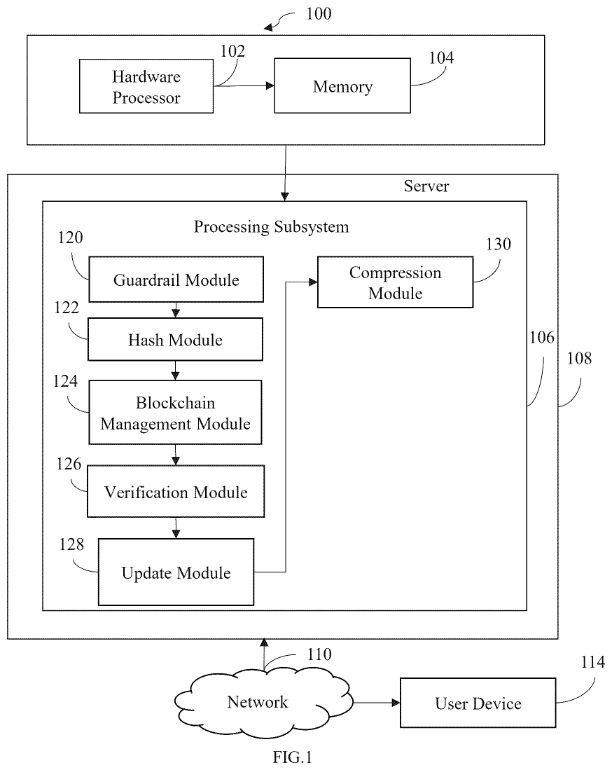

FIG. 1 is a block diagram representation of a system to detect and prevent tampering in user-artificial intelligence conversations in accordance with an embodiment of the present disclosure. The system 100 includes a hardware processor 101, and a memory 104 coupled to the hardware processor 101. The memory 104 comprises a set of program instructions in the form of a processing subsystem 106 hosted on a server 108. In one embodiment, the server 108 may include a cloud server. In another embodiment, the server 108 may include a local server. The processing subsystem 106 is configured to execute on a network 110 to control bidirectional communications among a plurality of modules. In one embodiment, the network 110 may include a wired network such as a local area network (LAN) or Wide Area Network (WAN), such as the Internet. In another embodiment, the network 110 may include both wired and wireless communications according to one or more standards and/or via one or more transport mediums. In one example, the network 110 may include wireless communications according to one of the 802.11 or Bluetooth specification sets, or another standard or proprietary wireless communication protocol. In yet another embodiment, the network 110 may also include communications over a terrestrial cellular network, including, a global system for mobile communications (GSM), code division multiple access (CDMA), and/or enhanced data for global evolution (EDGE) network.

The processing subsystem 106 includes a guardrail module 120. The guardrail module configured to receive a prompt to initiate a user-artificial intelligence conversation from the user operating a user device 114 and determine whether the prompt comprises a policy violation. The guardrail module 120 may include a policy evaluation engine configured to analyse semantic content, syntactic structure, contextual intent, and metadata associated with prompt prior to submission to artificial intelligence model. The policy violation may correspond to security policies, usage restrictions, regulatory compliance rules, content moderation guidelines, or predefined operational constraints stored within memory 104. The guardrail module 120 may further perform normalization of prompt, tokenization of prompt, contextual cross-referencing with block-chained conversation history, and rule-based or model-based classification to evaluate compliance. In formal notation, the conversation may be represented as:

$${C}_{s : t} = [ ( {p}_{s} , {v}_{s} , {r}_{s} ) , … , ( {p}_{t - 1} , {v}_{t - 1} , {r}_{t - 1} ) ] , t \geq s$$

where each conversation entry comprises prompt p_{τ}, violation indicator v_{τ}, and response r_{τ}. The guardrail module 120 determines violation indicator vₜ₋₁ corresponding to received prompt p_{new}. Guardrail module 120 may include policy evaluation engine configured to analyse semantic content, syntactic structure, contextual intent, and metadata associated with prompt prior to submission to artificial intelligence model. The policy violation may correspond to security policies, usage restrictions, regulatory compliance rules, content moderation guidelines, or predefined operational constraints stored within memory 104. The guardrail module 120 may further perform normalization, tokenization, contextual cross-referencing with block-chained conversation history, and rule-based or model-based classification to evaluate compliance.

In one embodiment, guardrail module 120 is configured to replace prompt with null value upon determination of policy violation. The conversation structure may be formally represented as:

$${C}_{s : t} = [ ( {p}_{s} , {v}_{s} , {r}_{s} ) , … , ( {p}_{t - 1} , {v}_{t - 1} , {r}_{t - 1} ) ] , t \geq s$$

where each entry comprises prompt p_{τ}, violation indicator v_{τ}, and response r_{τ}. Upon determination that vₜ₋₁=BLOCK, substitution occurs according to:

$${p}_{t - 1} = \{ \begin{matrix}{p}_{new} , & {v}_{t - 1} \neq BLOCK \\ ∅ , & {v}_{t - 1} = BLOCK\end{matrix}$$

The replacement operation occurs immediately after evaluation and prior to transmission of prompt to artificial intelligence model. Null value may represent empty token, predefined placeholder, zero-length string, or reserved system indicator stored within memory 104. Replacement mechanism prevents storage or propagation of policy-violating content within block-chained conversation history while maintaining structural continuity of conversation entries.

An example of guardrail module 120 includes, but is not limited to, a rule-based filtering engine, a machine learning-based content classifier, a natural language understanding component, a policy database.

In one embodiment, the guardrail module 120 configured to replace the prompt with a null value upon determination of the policy violation. Conversation structure may be formally represented as:

$${C}_{s : t} = [ ( {p}_{s} , {v}_{s} , {r}_{s} ) , … , ( {p}_{t - 1} , {v}_{t - 1} , {r}_{t - 1} ) ] , t \geq s$$

where each entry comprises prompt p_{τ}, violation indicator v_{τ}, and response r_{τ}. Upon determination that vₜ₋₁=BLOCK, substitution occurs according to:

$${p}_{t - 1} = \{ \begin{matrix}{p}_{new} , & {v}_{t - 1} \neq BLOCK \\ ∅ , & {v}_{t - 1} = BLOCK\end{matrix}$$

The replacement operation may occur immediately after evaluation of the prompt and prior to transmission of the prompt to the artificial intelligence model. The null value may represent an empty token, a predefined placeholder, a zero-length string, or a reserved system indicator stored within memory 104. Replacement mechanism ensures prevention of storage or propagation of policy-violating content within the block-chained conversation history while maintaining structural continuity of the plurality of conversation entries. The guardrail module 120 may associate the null value with a violation flag or metadata marker to preserve auditability without exposing original prompt content.

An example of the null value implementation includes, but is not limited to, insertion of a standardized null token in place of the prompt, substitution with an encoded empty field within a conversation entry, storage of a masked placeholder string within database, or assignment of a system-generated neutral identifier.

In one embodiment, the processing subsystem 106 includes a hash module 122 operatively coupled to the guardrail module 120. The hash module 122 comprises a proof-of-knowledge hash function. The proof-of-knowledge hash function may incorporate a high-entropy server-side secret into a hashing computation so that generation of a valid message hash and a valid chain hash requires knowledge of the high-entropy server-side secret. Such configuration makes sure that any external entity lacking access to the high-entropy server-side secret is unable to recompute or forge a valid hash corresponding to a conversation entry within block-chained conversation history. The hash module 122 may receive sanitized prompt output from the guardrail module 120 and combine prompt content, response content, and prior chain hash values with the high-entropy server-side secret to generate cryptographically verifiable outputs.

In one embodiment, processing subsystem 106 includes hash module 122 comprising proof-of-knowledge hash function incorporating server-side secret S. Secured conversation history is structured as:

$${\underline{C}}_{s : t} = [ ( {p}_{s} , {h}_{s}^{-} , {h}_{s} , {v}_{s} , {r}_{s} ) , … , ( {p}_{t - 1} , {h}_{t - 1}^{-} , {h}_{t - 1} , {v}_{t - 1} , {r}_{t - 1} ) ]$$

Message hash computation follows:

$${h}_{τ} = \{ \begin{matrix}{H}_{S} ( {p}_{τ} , {r}_{τ} ) , & {p}_{τ} ∉ \{ null , ∅ \} \\ 0 , & otherwise\end{matrix}$$

Chain hash computation follows:

$${h}_{τ}^{-} = \{ \begin{matrix}{H}_{S} ( {p}_{τ} , {r}_{τ} , {h}_{τ - 1}^{-} ) , & {h}_{τ - 1} \neq 0 \\ {h}_{τ - 2}^{-} , & {h}_{τ - 1} = 0\end{matrix}$$

Incorporation of the secret S ensures only a trusted server can compute the valid cryptographic linkage.

An example of the proof-of-knowledge hash function includes, but is not limited to, a keyed-hash message authentication code (HMAC), a salted SHA-based construction, a keyed Blake2 function, or a secret-seeded cryptographic digest algorithm.

In one embodiment, the hash module 122 is configured to generate a high-entropy server-side secret using a cryptographically secure random number generator and store the high-entropy server-side secret in a database. The high-entropy server-side secret may comprise a randomly generated bit sequence having sufficient length and unpredictability to resist brute-force computation and statistical inference. The cryptographically secure random number generator may be executed by hardware processor 102 within processing subsystem 106 to ensure entropy derived from system-level randomness sources such as hardware noise, timing variations, or operating system entropy pools. The high-entropy server-side secret may be generated during initialization of server 108, during deployment of processing subsystem 106, or during a scheduled rotation interval to enhance cryptographic resilience.

An example of the cryptographically secure random number generator includes, but is not limited to, a hardware-based entropy generator integrated, an operating system cryptographic random function, a deterministic random bit generator compliant with cryptographic standards, or a secure library-based entropy provider.

In one embodiment, the hash module 122 is configured to apply a secure hash function salted with the server-side secret to generate a message hash and a chain hash corresponding to each of a plurality of conversation entries of a block-chained conversation history. The secure hash function may receive as input a prompt corresponding to a conversation entry, a response corresponding to a conversation entry, and a preceding chain hash associated with a prior conversation entry, wherein the server-side secret is incorporated as a salt to ensure uniqueness and resistance to forgery. The message hash may represent a cryptographic digest of the prompt and the response associated with a conversation entry, while chain hash may represent a cryptographic linkage combining the message hash with a preceding chain hash to preserve ordered continuity of the plurality of conversation entries. The salting operation using the server-side secret ensures that identical prompt and response pairs produce different hash outputs across independent deployments.

An example of the secure hash function includes, but is not limited to, a keyed-hash message authentication code algorithm, a salted SHA-256 computation, a Blake2 keyed digest, or a cryptographic digest algorithm incorporating a secret key stored within database and accessed by processing subsystem 106.

In one embodiment, the hash module 122 is configured to assign a predefined zero value as the message hash when a prompt corresponding to a conversation entry of the plurality of conversation entries is the null value. Predefined zero value may represent a deterministic constant reserved within processing subsystem 106 to indicate absence of valid prompt content within a conversation entry. The assignment of predefined zero value ensures structural preservation of the plurality of conversation entries within the block-chained conversation history while preventing inclusion of policy-violating or removed prompt content in cryptographic computation. The predefined zero value may be defined as a fixed-length bit sequence, a zeroed digest matching output length of the secure hash function, or a system-reserved null hash identifier.

An example of predefined zero value includes, but is not limited to, a 256-bit zero sequence corresponding to SHA-256 output length, a constant hexadecimal string reserved by hash module 122, a system-generated null digest stored within database, or a cryptographic constant maintained.

In one embodiment, the processing subsystem 106 includes a blockchain management module 124 operatively coupled to the hash module 122. The blockchain management module is configured to record the plurality of conversation entries on a blockchain to generate the block-chained conversation history. Each conversation entry of the plurality of conversation entries may include a prompt corresponding to the conversation entry, a response generated by an artificial intelligence model corresponding to the conversation entry, a message hash corresponding to the conversation entry, and a chain hash corresponding to the conversation entry. The recording operation may involve sequentially appending each conversation entry to a ledger structure maintained within server 108, wherein chain hash corresponding to a current conversation entry references a preceding chain hash corresponding to a prior conversation entry to preserve chronological linkage. The blockchain implemented by blockchain management module 124 may comprise an append-only data structure,

An example of blockchain implementation includes, but is not limited to, an internal append-only hash chain maintained, a distributed ledger framework deployed across multiple servers, a tamper-evident log database, or a cryptographically linked record structure stored within database.

In one embodiment, each of the plurality of conversation entries comprises the prompt corresponding to the conversation entry, a response generated by an artificial intelligence model corresponding to the conversation entry, the message hash corresponding to the conversation entry, and the chain hash corresponding to the conversation entry. The prompt corresponding to the conversation entry may represent input content received from user through user device 114, after evaluation and possible null substitution performed by the guardrail module 120. The response corresponding to the conversation entry may represent output content generated by the artificial intelligence model in response to the prompt corresponding to the conversation entry. The message hash corresponding to the conversation entry may represent a cryptographic digest generated by hash module 122 using the prompt corresponding to the conversation entry and the response corresponding to the conversation entry, while chain hash corresponding to the conversation entry may represent a cryptographic linkage combining the message hash with a preceding chain hash to preserve ordered continuity within block-chained conversation history.

An example of the conversation entry includes, but is not limited to, a structured data record stored in database, a serialized JSON object maintained in memory 104, a ledger block maintained by blockchain management module 124, or a cryptographically linked log record stored within processing subsystem 106.

In one embodiment, the blockchain management module 124 is configured to append a new conversation entry corresponding to a new prompt to the plurality of conversation entries of the block-chained conversation history based on the message hash and the chain hash corresponding to the new conversation entry. The new prompt may be received from user through user device 114 and processed by guardrail module 120 prior to hash computation. Message hash corresponding to the new conversation entry may be generated by hash module 122 using the new prompt and a response generated by the artificial intelligence model. The chain hash corresponding to the new conversation entry may be computed by combining the message hash corresponding to the new conversation entry with a preceding chain hash corresponding to a most recent conversation entry of the plurality of conversation entries. The appending operation may include validating linkage consistency, updating index position within the plurality of conversation entries, and committing the new conversation entry to storage within memory 104 or database associated with server 108.

The blockchain management module 124 records the plurality of conversation entries sequentially according to secured structure above. Appending new conversation entry corresponding to new prompt p_{new} is expressed as:

$${\underline{C}}_{{s}_{t} : t} = \underline{G} ( {p}_{new} , {\underline{C}}_{{s}_{t - 1} : t - 1} ) , {s}_{t} \geq {s}_{t - 1}$$

where the linkage continuity is preserved through dependency of each

$${h}_{τ}^{-}$$

on preceding hash value. For initial entry, predefined genesis hash may be used.

An example of appending operation includes, but is not limited to, inserting a new block in an append-only ledger, updating a linked-list structure, writing a serialized conversation entry into a persistent storage table, or broadcasting a new record.

In one embodiment, the blockchain management module 124 is configured to maintain continuity of the block-chained conversation history by linking the chain hash corresponding to each conversation entry of the plurality of conversation entries to a preceding chain hash corresponding to a prior conversation entry of the plurality of conversation entries. The linking operation may involve incorporating the preceding chain hash as an input parameter during computation of the chain hash corresponding to a current conversation entry, thereby creating a cryptographic dependency between sequential conversation entries. Such dependency ensures that the chain hash corresponding to a current conversation entry reflects both content of the current conversation entry and positional context within the plurality of conversation entries. For an initial conversation entry, a predefined initialization value may be used as a preceding chain hash to establish a genesis linkage.

An example of linking mechanism includes, but is not limited to, concatenation of the message hash corresponding to a current conversation entry with the preceding chain hash prior to secure hash computation, use of a keyed chaining function implemented by hash module 122, maintenance of a hash pointer structure, or construction of a linked ledger block.

In one embodiment, the blockchain management module 124 is configured to truncate the block-chained conversation history backwards in time using a sliding window mechanism specifically tailored for blockchain-based artificial intelligence model conversation history. The truncation may involve removing one or more earliest conversation entries from the plurality of conversation entries while preserving structural integrity of remaining conversation entries. The sliding window mechanism may define a dynamic boundary based on context length constraints, storage thresholds, computational efficiency requirements, or predefined policy limits maintained within processing subsystem 106. The sliding window mechanism may retain a most recent subset of the plurality of conversation entries and discard older conversation entries beyond a defined boundary, while preserving a final chain hash corresponding to a last retained conversation entry to maintain cryptographic continuity.

An example of sliding window mechanism includes, but is not limited to, a fixed-size window retaining a predetermined number of recent conversation entries, a time-based window retaining conversation entries within a defined temporal interval, a token-length-based window retaining conversation entries within a defined token threshold, or an adaptive window dynamically adjusted by server 108 based on performance metrics.

In another embodiment, the sliding window mechanism is configured to preserve at least one final chain hash corresponding to a most recent conversation entry of the plurality of conversation entries after truncation of the block-chained conversation history. The preservation operation may involve retaining the chain hash corresponding to the most recent conversation entry remaining within the plurality of conversation entries following backward truncation. The final chain hash may serve as a cryptographic anchor for subsequent computation of a chain hash corresponding to a new conversation entry appended after truncation. The sliding window mechanism may therefore remove one or more earlier conversation entries while maintaining continuity of hash linkage beginning from the preserved final chain hash.

During truncation, the sliding window mechanism removes the most recent conversation entry while preserving final chain hash

$${h}_{anchor}^{-} .$$

Subsequent append operations reference preserved the anchor hash, maintaining continuity without full history retention.

An example of preservation includes, but is not limited to, storing the final chain hash as a retained anchor value, maintaining the final chain hash within database as a checkpoint reference, marking the most recent conversation entry as a continuation boundary, or recording the final chain hash as a trusted linkage reference.

In one embodiment, the blockchain management module 124 is configured to remove one or more prompts that were replaced with the null value and store the one or more prompts as the null value within the plurality of conversation entries. The removal operation may involve eliminating original prompt content identified as containing a policy violation while retaining structural position of a corresponding conversation entry within the plurality of conversation entries. The storage of the one or more prompts as the null value ensures preservation of index ordering, message hash determinism, and chain hash continuity without reintroducing restricted content. The null value may remain associated with metadata indicating prior replacement by guardrail module 120, thereby enabling traceability without disclosure of original prompt content.

An example of removal and storage mechanism includes, but is not limited to, overwriting original prompt content with a predefined null token within database, masking prompt field in a structured JSON record, replacing prompt content with a system-generated placeholder within a ledger block maintained by blockchain management module 124, or maintaining a null indicator flag.

In one embodiment, the blockchain management module 124 is configured to treat the new prompt as a continuation of the block-chained conversation history from a point at which the block-chained conversation history was previously truncated based on an edit made to an earlier prompt. The edit operation may involve modification of a prior conversation entry within the plurality of conversation entries, resulting in removal of one or more subsequent conversation entries positioned after the edited conversation entry. The truncation following the edit ensures elimination of dependent conversation entries that were generated based on content of the earlier prompt prior to modification. The new prompt submitted after the edit may therefore be appended beginning from a last retained conversation entry corresponding to the truncation boundary. The chain hash corresponding to the last retained conversation entry may serve as a cryptographic anchor for computation of a new chain hash corresponding to the new prompt and a response generated by the artificial intelligence model.

The verification module 126 recomputes cryptographic values to validate integrity. Integrity condition requires:

$${h}_{τ}^{stored} = {H}_{S} ( {p}_{τ} , {r}_{τ} ) and$$

$${h}_{τ}^{- stored} = {H}_{S} ( {p}_{τ} , {r}_{τ} , {h}_{τ - 1}^{-} )$$

Detection of discrepancy occurs when:

$${h}_{τ}^{stored} \neq {h}_{τ}^{recomputed} or {h}_{τ}^{- stored} \neq {h}_{τ}^{- recomputed}$$

Such deviation indicates tampering within the block-chained conversation history.

An example of continuation mechanism includes, but is not limited to, removal of trailing conversation entries in database following modification of an earlier conversation entry, recalculation of chain linkage from a truncation boundary, reinitialization of append pointer, or generation of a new branch sequence anchored to a preserved chain hash.

In another embodiment, the blockchain management module 124 is configured to skip a conversation entry of the plurality of conversation entries having the predefined zero value as the message hash when computing a subsequent chain hash corresponding to another conversation entry of the plurality of conversation entries. The skipping operation may occur when a prompt corresponding to a conversation entry has been replaced with the null value and the message hash corresponding to the conversation entry has been assigned the predefined zero value by hash module 122. During computation of a subsequent chain hash, blockchain management module 124 may reference a preceding non-zero chain hash corresponding to a prior valid conversation entry instead of incorporating the predefined zero value. Such conditional chaining preserves continuity while preventing distortion of cryptographic linkage caused by placeholder values.

An example of skipping mechanism includes, but is not limited to, conditional exclusion of zero-valued message hash during hash concatenation, selective retrieval of a prior non-zero chain hash from database, maintenance of a pointer to a last valid conversation entry, or execution of controlled chaining logic.

In one embodiment, the processing subsystem 106 includes a verification module 126 operatively coupled to the blockchain management module and the hash module. The verification module is configured to verify integrity of the block-chained conversation history prior to processing the new prompt by recomputing the message hash corresponding to each conversation entry of the plurality of conversation entries and the chain hash corresponding to each conversation entry of the plurality of conversation entries. The recomputing operation may involve retrieving the prompt corresponding to a conversation entry, the response corresponding to a conversation entry, and a preceding chain hash corresponding to a prior conversation entry, and applying the secure hash function salted with the server-side secret to regenerate the message hash and the chain hash. The verification module 126 may sequentially iterate through the plurality of conversation entries in chronological order to ensure deterministic re-computation across entire block-chained conversation history. The comparison between recomputed values and stored values enables identification of any deviation within prompt content, response content, ordering, or linkage.

An example of integrity verification includes, but is not limited to, sequential ledger validation, hash re-computation using keyed digest, validation of hash pointers within database, or distributed node consensus validation.

In one embodiment, the verification module 126 is configured to verify correctness of the chain hash corresponding to each conversation entry of the plurality of conversation entries to ensure continuity of the block-chained conversation history remains unbroken. The verification of correctness may involve recalculating the chain hash corresponding to a current conversation entry by combining the message hash corresponding to the current conversation entry with a preceding chain hash corresponding to a prior conversation entry using the secure hash function salted with the server-side secret. The verification module 126 may compare the recalculated chain hash with a stored chain hash associated with the current conversation entry to confirm consistency. Such verification may be performed sequentially across the plurality of conversation entries beginning from an initial conversation entry associated with a predefined initialization value.

An example of correctness verification includes, but is not limited to, hash pointer validation within an append-only ledger maintained by blockchain management module 124, chained digest re-computation, integrity checking within database records storing the plurality of conversation entries, or consensus-based verification across distributed nodes.

In one embodiment, the verification module 126 is configured to detect one or more discrepancies between a recomputed message hash corresponding to a conversation entry of the plurality of conversation entries or a recomputed chain hash corresponding to a conversation entry of the plurality of conversation entries and a corresponding stored message hash or a corresponding stored chain hash of the block-chained conversation history. The detection operation may include performing a value-by-value comparison between each recomputed message hash and stored message hash associated with a respective conversation entry, and between each recomputed chain hash and stored chain hash associated with the respective conversation entry. The verification module 126 may iterate sequentially through the plurality of conversation entries to identify any mismatch, inconsistency, truncation anomaly, insertion irregularity, or reordering deviation within block-chained conversation history.

The update module 128 processes the new prompt only after successful verification. The message hash and chain hash for new conversation entry are computed as:

$${h}_{τ - 1} = \{ \begin{matrix}{H}_{S} ( {p}_{τ - 1} , {r}_{τ - 1} ) , & {p}_{τ - 1} \neq ∅ \\ 0 , & {p}_{τ - 1} = ∅\end{matrix}$$

$${h}_{τ - 1}^{-} = \{ \begin{matrix}{H}_{S} ( {p}_{τ - 1} , {r}_{τ - 1} , {h}_{τ - 2}^{-} ) , & {h}_{τ - 2} \neq 0 \\ {h}_{t - 3}^{-} , & {h}_{τ - 2} = 0\end{matrix}$$

New entry

$$( {p}_{t - 1} , {h}_{t - 1}^{-} , {h}_{t - 1} , {v}_{t - 1} , {r}_{t - 1} )$$

is appended to secured ledger.

An example of discrepancy detection includes, but is not limited to, bitwise comparison of digest outputs, integrity validation routines executed against database records storing conversation entries, threshold-based anomaly detection for unexpected hash patterns, or distributed consensus validation across nodes.

In one embodiment, the verification module 126 is configured to identify a tampering of the block-chained conversation history upon detection of the one or more discrepancies. Identification process may involve classifying a detected discrepancy as an integrity violation based on comparison results generated during re-computation of the message hash and the chain hash corresponding to each conversation entry of the plurality of conversation entries. The verification module 126 may generate a tampering indicator, a status flag, or a security event record stored the database to formally mark block-chained conversation history as compromised. The identification may further include associating a specific conversation entry index, timestamp, or hash reference with the detected discrepancy to enable traceability and audit review.

An example of tampering identification includes, but is not limited to, generation of an integrity violation log, updating a security status field in database associated with server 108, triggering a tamper state variable within verification module 126, or initiating a blockchain integrity alert.

In another embodiment, the verification module 126 is further configured to block processing of the new prompt when the verification module determines that the block-chained conversation history has been tampered with. Blocking operation may involve preventing transmission of the new prompt to the artificial intelligence model, suspending execution of the update module 128, and halting computation of the message hash and the chain hash associated with a new conversation entry. The verification module 126 may generate a control signal within processing subsystem 106 to terminate continuation of user-artificial intelligence conversation until integrity of the block-chained conversation history is restored. The blocking mechanism may further include restricting access to the plurality of conversation entries, isolating compromised conversation entries, and preventing additional appending operations within blockchain management module 124.

An example of blocking operation includes, but is not limited to, disabling execution threads, locking database records storing the plurality of conversation entries, invalidating a session associated with user operating user device 114, or triggering a security control routine.

In another embodiment, the verification module 126 is further configured to generate an alert notification when the verification module 126 determines that the block-chained conversation history has been tampered with. Alert notification may be generated after detection of one or more discrepancies between a recomputed message hash or a recomputed chain hash and corresponding stored values within the plurality of conversation entries. Alert notification may include information identifying an affected conversation entry, a timestamp associated with detection, a hash reference indicating location of discrepancy, and a severity classification level. The alert notification may be transmitted to an administrator interface, a monitoring service, a security dashboard, or a logging repository associated with server 108.

An example of alert notification includes, but is not limited to, generation of a system log entry, transmission of a security message to an administrative user device, triggering of an event within a security information and event management platform, or activation of a visual or audible indicator.

In one embodiment, processing subsystem 106 includes an update module 128 operatively coupled to the guardrail module 120, the verification module 126, and the blockchain management module 124. The update module 128 is configured to process the new prompt upon successful verification of the block-chained conversation history to determine whether the new prompt comprises a policy violation and replace the new prompt with the null value when the new prompt comprises the policy violation. The processing of the new prompt may occur only after verification module 126 confirms integrity of the plurality of conversation entries, thereby ensuring continuation of user-artificial intelligence conversation from a trusted state. The determination of policy violation may involve evaluation of semantic content, syntactic structure, contextual dependencies, and predefined compliance rules maintained within database. When policy violation is identified, replacement of the new prompt with the null value ensures prevention of restricted content from influencing subsequent hash computation and blockchain recording.

An example of processing and replacement includes, but is not limited to, invocation of a rule-based policy engine, execution of a machine learning classifier for content moderation, substitution of the new prompt with a predefined null token, or masking of new prompt content within a structured conversation entry stored in database

In one embodiment, the update module 128 is configured to generate a response corresponding to the new prompt using the artificial intelligence model. The generation of the response may occur after evaluation of the new prompt and replacement of the new prompt with the null value when a policy violation is identified, thereby ensuring only validated content proceeds to the artificial intelligence model. The artificial intelligence model may process semantic structure, contextual dependencies, historical context derived from the plurality of conversation entries, and relevant domain knowledge to produce the response corresponding to the new prompt. The response generation may involve tokenization, contextual embedding, inference computation, and probabilistic decoding.

In one embodiment, the invocation of artificial intelligence model occurs through a secured generative function operating over the block-chained conversation history. The secured call may be formally represented as:

$${\underline{C}}_{{s}_{t} : t} = \underline{G} ( {p}_{new} , {\underline{C}}_{{s}_{t - 1} : t - 1} ) , {s}_{t} \geq {s}_{t - 1}$$

where G represents secured generative function incorporating verification constraints and guardrail enforcement.

A structural property of secured generative function is defined as:

$$\underline{G} ( {p}_{new} , \underline{C} ) = \underline{G} ( {p}_{new} , STRIP ( \underline{C} ) )$$

where STRIP(C) removes conversation entries having the message hash equal to zero.

An example of the artificial intelligence model includes, but is not limited to, a transformer-based language model deployed, a neural network inference engine, a fine-tuned conversational model, or a distributed inference service.

In one embodiment, the update module 128 is configured to compute the message hash corresponding to a new conversation entry and the chain hash corresponding to the new conversation entry. The new conversation entry may comprise the new prompt and a response corresponding to the new prompt generated by the artificial intelligence model. The message hash corresponding to the new conversation entry may be computed by applying the secure hash function salted with the server-side secret to the new prompt and the response corresponding to the new prompt. The chain hash corresponding to the new conversation entry may be computed by combining the message hash corresponding to the new conversation entry with a preceding chain hash corresponding to a most recent conversation entry of the plurality of conversation entries.

An example of hash computation includes, but is not limited to, generation of a keyed digest using a salted SHA-256 algorithm, execution of a keyed Blake2 function with incorporation of the preceding chain hash, application of a message authentication code algorithm, or secure chaining operation implemented within database.

In one embodiment, the update module 128 is configured to update the block-chained conversation history by appending the new conversation entry to the plurality of conversation entries. The appending operation may involve inserting the new conversation entry at a terminal position within the plurality of conversation entries maintained in database. The update operation may further include indexing the new conversation entry, committing the new conversation entry to persistent storage, and linking the chain hash corresponding to the new conversation entry with a preceding chain hash corresponding to a most recent conversation entry.

In one embodiment, the new conversation entry comprising the new prompt, the response, the message hash, and the chain hash.

An example of update operation includes, but is not limited to, writing the new conversation entry as a new ledger block within an append-only blockchain structure, adding a serialized record into a structured storage table, updating a linked data structure maintained, or synchronizing the updated plurality of conversation entries across distributed nodes.

In one embodiment, the processing subsystem 106 includes a compression module 130 operatively coupled to the blockchain management module 124. The compression module 130 is configured to generate a compressed conversation summary based on at least one portion of the block-chained conversation history. The generation of the compressed conversation summary may involve semantic extraction of key information, removal of redundant content, contextual abstraction, and synthesis of essential conversational elements while preserving logical continuity of user-artificial intelligence conversation. The compression module 130 may analyse prompts corresponding to conversation entries and responses corresponding to conversation entries to produce a condensed representation suitable for continued interaction with the artificial intelligence model.

An example of compressed conversation summary generation includes, but is not limited to, execution of a summarization algorithm, application of a transformer-based summarization model deployed, rule-based aggregation of salient conversation elements, or generation of a condensed ledger record maintained within database.

In one embodiment, the compression module 130 is configured to recompute the message hash corresponding to the compressed conversation summary and the chain hash to preserve an integrity of the block-chained conversation history. The compressed conversation summary may be treated as a new conversation entry replacing at least a portion of the plurality of conversation entries retained prior to compression. The message hash corresponding to the compressed conversation summary may be generated by applying the secure hash function salted with the server-side secret to the compressed conversation summary. Chain hash corresponding to the compressed conversation summary may be computed by combining the message hash corresponding to the compressed conversation summary with a preceding chain hash corresponding to a most recent retained conversation entry. The recomputed values may then be stored within database to maintain ordered continuity within block-chained conversation history.

During the compression, the compressed conversation summary p_{comp} is treated as new entry replacing truncated portion. The re-anchoring is performed using:

$${h}_{comp} = {H}_{S} ( {p}_{comp} , {r}_{comp} )$$

$${h}_{comp}^{-} = {H}_{S} ( {p}_{comp} , {r}_{comp} , {h}_{anchor}^{-} )$$

where

$${h}_{anchor}^{-}$$

represents preserved chain hash from retained portion. The recomputed values are stored to maintain the ordered continuity.

An example of re-computation includes, but is not limited to, execution of a keyed digest algorithm, generation of a chained hash pointer within blockchain management module 124, recalculation of ledger linkage following summarization, or secure re-anchoring of compressed data within an append-only blockchain structure.

In another embodiment, the compression module 130 is configured to transmit at least one portion of the block-chained conversation history to the artificial intelligence model for summarization prior to recomputing the message hash corresponding to the compressed conversation summary and the chain hash corresponding to the compressed conversation summary. At-least one portion of the block-chained conversation history may comprise a selected subset of the plurality of conversation entries determined according to context length constraints, storage optimization policies, or operational parameters maintained within processing subsystem 106. The transmission may occur through server 108 over network 110 or internally within processing subsystem 106 when the artificial intelligence model is locally deployed. The artificial intelligence model may process prompts corresponding to conversation entries and responses corresponding to conversation entries to generate a compressed conversation summary representing essential semantic content while reducing overall size.

An example of transmission and summarization includes, but is not limited to, sending serialized conversation entries from database to an inference engine, invoking a transformer-based summarization model, executing a neural network summarizer, or transmitting conversation data across network to a distributed artificial intelligence service.

In another embodiment, the processing subsystem 106 is configured to operate in at least one of a stateful service architecture and a stateless service architecture while maintaining integrity of the block-chained conversation history. The stateful service architecture may retain the plurality of conversation entries during an active session, allowing direct access to stored message hash values and chain hash values for real-time verification and update operations. Stateless service architecture may reconstruct required conversational context for each request by retrieving the plurality of conversation entries or a retained final chain hash from database prior to performing verification and hashing operations. The processing subsystem 106 may dynamically switch between stateful service architecture and stateless service architecture based on deployment configuration, scalability requirements, or network 110 constraints.

An example of stateful service architecture includes, but is not limited to, session-based storage of conversation entries within server 108 memory, in-memory ledger maintenance within processing subsystem 106, or persistent connection handling between user device 114 and server 108.

An example of stateless service architecture includes, but is not limited to, request-based retrieval of conversation entries from database, microservice-based, or tokenized context reconstruction using a stored chain hash reference.

In a real-life non-limiting example, system 100 may be deployed within a cloud-based enterprise conversational support platform operated by a financial services organization. In such deployment, user operates user device 114, such as a mobile application or web interface, to interact with server 108 hosting processing subsystem 106 across network 110. The user may initiate a user-artificial intelligence conversation to obtain account information, request transaction summaries, or seek procedural guidance. Guardrail module 120 evaluates each prompt received from user to determine whether prompt comprises a policy violation, such as an attempt to access restricted data, perform unauthorized actions, or submit malicious input. Upon identification of a policy violation, the guardrail module 120 replaces prompt with a null value to prevent restricted content from influencing subsequent processing.

In such deployment, hash module 122 generates a high-entropy server-side secret during initialization of server 108 and securely stores high-entropy server-side secret in database accessible exclusively to processing subsystem 106. The hash module 122 applies a secure hash function salted with high-entropy server-side secret to generate message hash and chain hash corresponding to each conversation entry of the plurality of conversation entries forming block-chained conversation history. The blockchain management module 124 records each conversation entry on a blockchain structure maintained within database, thereby creating a tamper-evident ledger of prompts and responses exchanged during user-artificial intelligence conversation. The verification module 126 recomputes message hash and chain hash prior to processing each new prompt to detect any discrepancy indicating unauthorized modification of stored conversation entries. Upon identification of tampering, verification module 126 may block further processing and generate an alert notification to a security monitoring interface

In another non-limiting example, system 100 may be deployed within a healthcare advisory platform where user interacts with a conversational model to obtain general medical guidance. The blockchain management module 124 maintains block-chained conversation history to ensure integrity of advice provided over multiple conversational turns. The compression module 130 may generate a compressed conversation summary when plurality of conversation entries exceeds predefined context limits, thereby enabling continued interaction without loss of cryptographic linkage. The processing subsystem 106 may operate in a stateless service architecture across distributed cloud nodes, wherein each request retrieves preserved final chain hash from database and reconstructs block-chained conversation history prior to verification and update operations. Such deployment ensures regulatory compliance, auditability, and tamper resistance in sensitive domains where integrity of conversational records is critical.

In yet another non-limiting example, system 100 may be integrated into a collaborative software development platform where developers interact with a conversational model for code generation and review. The blockchain management module 124 ensures that prior code-related prompts and responses cannot be selectively altered to manipulate subsequent outputs. The sliding window mechanism preserves at least one final chain hash after truncation of older conversation entries.

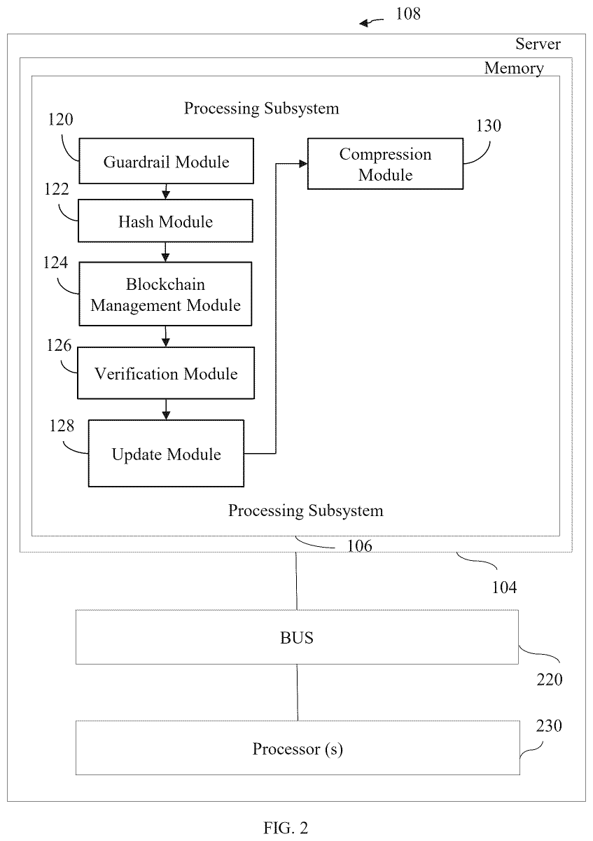

FIG. 2 is a block diagram of a computer or a server 108 in accordance with an embodiment of the present disclosure. The server 108 includes processor(s) 230, and memory 104 operatively coupled to the bus 220. The processor(s) 230, as used herein, means any type of computational circuit, such as, but not limited to, a microprocessor, a microcontroller, a complex instruction set computing microprocessor, a reduced instruction set computing microprocessor, a very long instruction word microprocessor, an explicitly parallel instruction computing microprocessor, a digital signal processor, or any other type of processing circuit, or a combination thereof.

The memory 104 includes several subsystems stored in the form of computer-readable medium which instructs the processor to perform the method steps illustrated in FIG. 1. The memory 104 includes several subsystems stored in the form of executable program which instructs the processor 230 to perform the method steps illustrated in FIG. 1. The memory 104 includes a processing subsystem 106 of FIG. 1. The processing subsystem 106 further has following modules: a guardrail module 120, a hash module 122, a blockchain management module 124, a verification module 126, an update module 128, and a compression module 130.

A system 100 to detect and prevent tampering in user-artificial intelligence conversations is provided. The system 100 includes a hardware processor 102, and a memory 104 coupled to the hardware processor 102. The memory 104 comprises a set of program instructions in the form of a processing subsystem 106 hosted on a server 108 and configured to execute on a network 110 to control bidirectional communications among a plurality of modules. The processing subsystem 106 includes a guardrail module 120. The guardrail module 120 configured to receive a prompt to initiate a user-artificial intelligence conversation from the user 112 operating a user device 114 and determine whether the prompt comprises a policy violation. The guardrail module 120 configured to replace the prompt with a null value upon determination of the policy violation. The processing subsystem 106 includes a hash module 122 operatively coupled to the guardrail module 120. The hash module 122 comprises a proof-of-knowledge hash function. The hash module 122 is configured to generate a high-entropy server-side secret using a cryptographically secure random number generator and store the high-entropy server-side secret in a database. The hash module 122 is configured to apply a secure hash function salted with the server-side secret to generate a message hash and a chain hash corresponding to each of a plurality of conversation entries of a block-chained conversation history. The hash module 122 is configured to assign a predefined zero value as the message hash when a prompt corresponding to a conversation entry of the plurality of conversation entries is the null value. The processing subsystem 106 includes a blockchain management module 124 operatively coupled to the hash module 122. The blockchain management module 124 is configured to record the plurality of conversation entries on a blockchain to generate the block-chained conversation history, wherein each of the plurality of conversation entries comprises the prompt corresponding to the conversation entry, a response generated by an artificial intelligence model corresponding to the conversation entry, the message hash corresponding to the conversation entry, and the chain hash corresponding to the conversation entry. The blockchain management module 124 is configured to append a new conversation entry corresponding to a new prompt to the plurality of conversation entries of the block-chained conversation history based on the message hash and the chain hash corresponding to the new conversation entry. The blockchain management module 124 is configured to maintain continuity of the block-chained conversation history by linking the chain hash corresponding to each conversation entry of the plurality of conversation entries to a preceding chain hash corresponding to a prior conversation entry of the plurality of conversation entries. The blockchain management module 124 is configured to truncate the block-chained conversation history backwards in time using a sliding window mechanism specifically tailored for blockchain-based artificial intelligence model conversation history. The blockchain management module 124 is configured to remove one or more prompts that were replaced with the null value and store the one or more prompts as the null value within the plurality of conversation entries. The blockchain management module 124 is configured to treat the new prompt as a continuation of the block-chained conversation history from a point at which the block-chained conversation history was previously truncated based on an edit made to an earlier prompt. The processing subsystem 106 includes a verification module 126 operatively coupled to the blockchain management module 124 and the hash module 122. The verification module 126 is configured to verify integrity of the block-chained conversation history prior to processing the new prompt by recomputing the message hash corresponding to each conversation entry of the plurality of conversation entries and the chain hash corresponding to each conversation entry of the plurality of conversation entries. The verification module 126 is configured to verify correctness of the chain hash corresponding to each conversation entry of the plurality of conversation entries to ensure continuity of the block-chained conversation history remains unbroken. The verification module 126 is configured to detect one or more discrepancies between a recomputed message hash corresponding to a conversation entry of the plurality of conversation entries or a recomputed chain hash corresponding to a conversation entry of the plurality of conversation entries and a corresponding stored message hash or a corresponding stored chain hash of the block-chained conversation history. The verification module 126 is configured to identify a tampering of the block-chained conversation history upon detection of the one or more discrepancies. The processing subsystem 106 includes an update module 128 operatively coupled to the guardrail module 120, the verification module 126, and the blockchain management module 124. The update module 128 is configured to process the new prompt upon successful verification of the block-chained conversation history to determine whether the new prompt comprises a policy violation and replace the new prompt with the null value when the new prompt comprises the policy violation. generate a response corresponding to the new prompt using the artificial intelligence model. The update module 128 is configured to compute the message hash corresponding to a new conversation entry and the chain hash corresponding to the new conversation entry. The update module is configured to update the block-chained conversation history by appending the new conversation entry to the plurality of conversation entries, wherein the new conversation entry comprising the new prompt, the response, the message hash, and the chain hash. The processing subsystem 106 includes a compression module 130 operatively coupled to the blockchain management module 124. The compression module 130 is configured to generate a compressed conversation summary based on at least one portion of the block-chained conversation history. The compression module 130 is configured to recompute the message hash corresponding to the compressed conversation summary and the chain hash to preserve an integrity of the block-chained conversation history.

While computer-readable medium is shown in an example embodiment to be a single medium, the term “computer-readable medium” should be taken to include a single medium or multiple media (for example, a centralized or distributed database, or associated caches and servers) able to store the instructions. The term “computer readable medium” shall also be taken to include any medium that is capable of storing instructions for execution by the machine and that cause the machine to perform any one or more of the methodologies disclosed herein. The term “computer-readable medium” includes, but not to be limited to, data repositories in the form of solid-state memories, optical media, and magnetic media.

The bus 220 as used herein refers to be internal memory channels or computer network that is used to connect computer components and transfer data between them. The bus 220 includes a serial bus or a parallel bus, wherein the serial bus transmits data in bit-serial format, and the parallel bus transmits data across multiple wires. The bus 220 as used herein may include but not limited to, a system bus, an internal bus, an external bus, an expansion bus, a frontside bus, a backside bus, and the like.

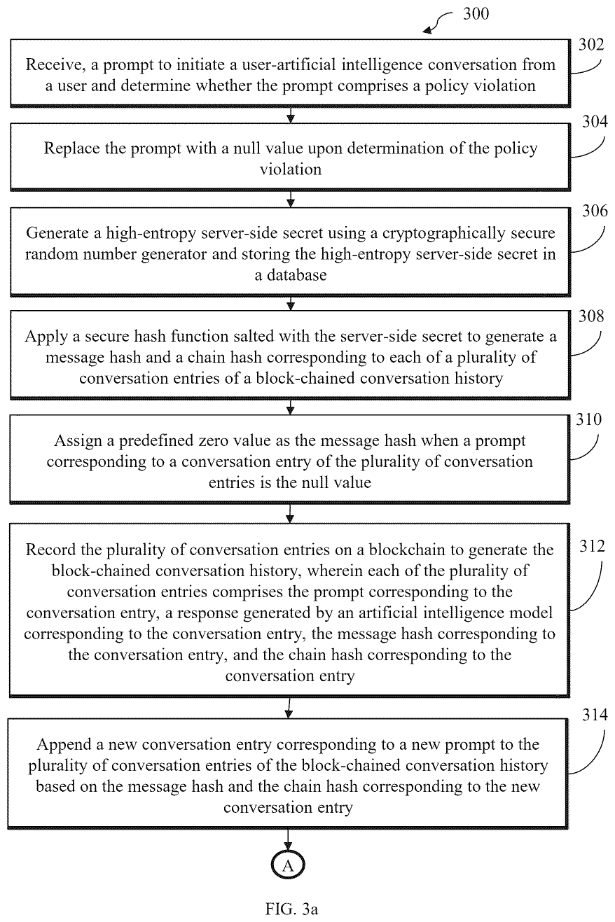

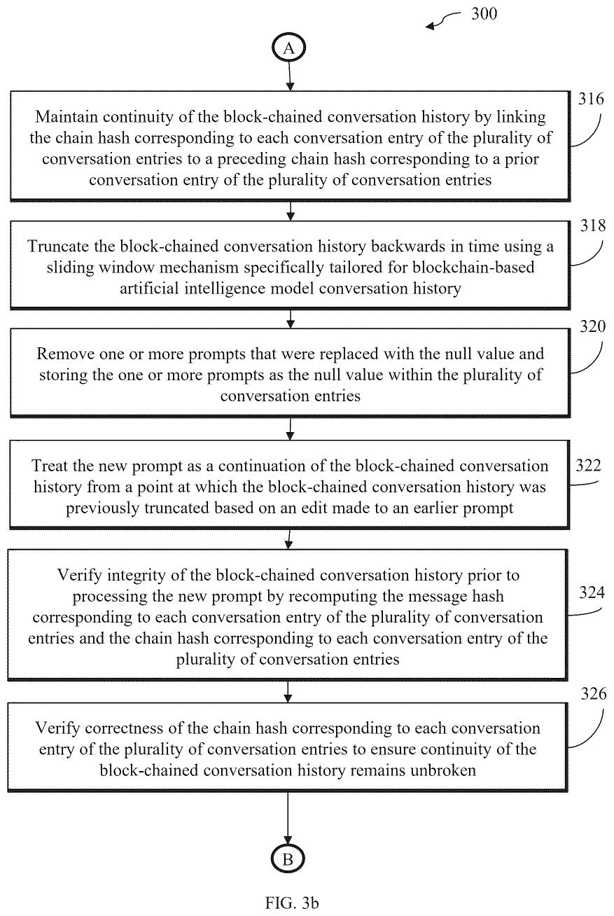

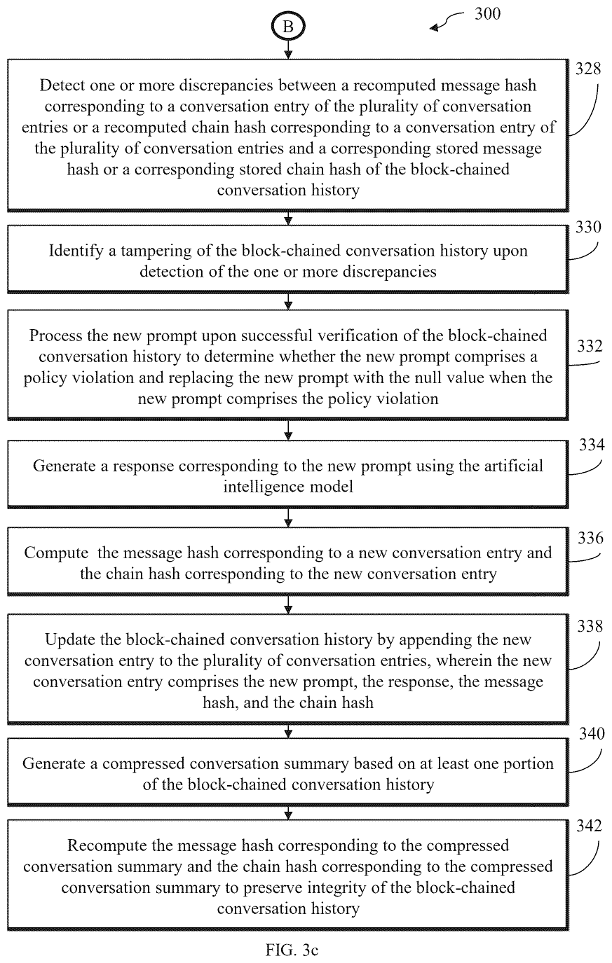

FIG. 3a is a flow chart representing the steps involved in a method to detect and prevent tampering in user-artificial intelligence conversations in accordance with an embodiment of the present disclosure; FIG. 3b is a flow chart representing the continued steps involved in a method of FIG. 3a, in accordance with an embodiment of the present disclosure; and FIG. 3c is a flow chart representing the continued steps involved in a method of FIG. 3b, in accordance with an embodiment of the present disclosure. The method 300 begins at step 302.

At step 302, receiving, a prompt to initiate a user-artificial intelligence conversation from a user and determine whether the prompt comprises a policy violation. The prompt may comprise textual content, structured data, or command instructions intended for processing by an artificial intelligence model. The determination of a policy violation may involve evaluating semantic content, contextual intent, and predefined compliance rules.

At step 304, replacing the prompt with a null value upon determination of the policy violation. The null value may represent an empty token, a reserved placeholder string, or a fixed-length zero sequence used to preserve structural position of a conversation entry within a plurality of conversation entries. The replacement operation prevents restricted content from being processed by an artificial intelligence model while maintaining ordered continuity.

At step 306, generating a high-entropy server-side secret using a cryptographically secure random number generator and storing the high-entropy server-side secret in a database. Cryptographically secure random number generator may be executed by a hardware processor to derive entropy from system-level sources. High-entropy server-side secret may be stored in a database accessible only to a processing subsystem to support secure hash computation.

At step 308, applying a secure hash function salted with the server-side secret to generate a message hash and a chain hash corresponding to each of a plurality of conversation entries of a block-chained conversation history. Message hash may represent a digest of the prompt and the response, while chain hash may combine the message hash with a preceding chain hash to preserve ordered linkage. The salting operation using the server-side secret ensures resistance against forgery and replay.

At step 310, assigning a predefined zero value as the message hash when a prompt corresponding to a conversation entry of the plurality of conversation entries is the null value. The predefined zero value may correspond to a fixed-length bit sequence equal to an output length of a secure hash function. The assignment makes sure preservation of structural position of the conversation entry while preventing inclusion of restricted content in cryptographic computation.

At step 312, recording the plurality of conversation entries on a blockchain to generate the block-chained conversation history, wherein each of the plurality of conversation entries comprises the prompt corresponding to the conversation entry, a response generated by an artificial intelligence model corresponding to the conversation entry, the message hash corresponding to the conversation entry, and the chain hash corresponding to the conversation entry. Each conversation entry comprises the prompt corresponding to the conversation entry, a response generated by an artificial intelligence model corresponding to the conversation entry, the message hash corresponding to the conversation entry, and the chain hash corresponding to the conversation entry. Blockchain structure may enforce ordered linkage through incorporation of a preceding chain hash during storage.

At step 314, appending a new conversation entry corresponding to a new prompt to the plurality of conversation entries of the block-chained conversation history based on the message hash and the chain hash corresponding to the new conversation entry. The message hash corresponding to the new conversation entry may be derived from the new prompt and a response generated for the new prompt, while chain hash corresponding to the new conversation entry may incorporate a preceding chain hash associated with a most recent conversation entry.

At step 316, maintaining continuity of the block-chained conversation history by linking the chain hash corresponding to each conversation entry of the plurality of conversation entries to a preceding chain hash corresponding to a prior conversation entry of the plurality of conversation entries. Linking operation creates a cryptographic dependency between sequential conversation entries within the plurality of conversation entries.

At step 318, truncating the block-chained conversation history backwards in time using a sliding window mechanism specifically tailored for blockchain-based artificial intelligence model conversation history. The truncation preserves a final chain hash corresponding to a most recent retained conversation entry to maintain cryptographic linkage. An example of sliding window mechanism includes, but is not limited to, a fixed-size window retaining a predetermined number of recent conversation entries, a time-based retention policy, or a dynamic context threshold maintained in memory.

At step 320, removing one or more prompts that were replaced with the null value and storing the one or more prompts as the null value within the plurality of conversation entries. Removing one or more prompts may overwrite original prompt data in a storage location and preserve a null value in a prompt field of the conversation entry.

At step 322, treating the new prompt as a continuation of the block-chained conversation history from a point at which the block-chained conversation history was previously truncated based on an edit made to an earlier prompt. An example of continuation includes, but is not limited to, resetting an append pointer in a blockchain ledger, recalculating a chaining reference in memory, or initiating a new sequence anchored to a preserved chain hash stored in a database.

At step 324, verifying integrity of the block-chained conversation history prior to processing the new prompt by recomputing the message hash corresponding to each conversation entry of the plurality of conversation entries and the chain hash corresponding to each conversation entry of the plurality of conversation entries. Recomputed message hash may be derived from a prompt and a response associated with a conversation entry, while recomputed chain hash may incorporate a preceding chain hash corresponding to a prior conversation entry.

At step 326, verifying correctness of the chain hash corresponding to each conversation entry of the plurality of conversation entries to ensure continuity of the block-chained conversation history remains unbroken. Recalculated chain hash may be compared with a stored chain hash corresponding to the current conversation entry to confirm consistency of cryptographic linkage.

At step 328, detecting one or more discrepancies between a recomputed message hash corresponding to a conversation entry of the plurality of conversation entries or a recomputed chain hash corresponding to a conversation entry of the plurality of conversation entries and a corresponding stored message hash or a corresponding stored chain hash of the block-chained conversation history. Comparison may be executed sequentially across the plurality of conversation entries to identify any mismatch in a message hash or a chain hash.

At step 330, identifying a tampering of the block-chained conversation history upon detection of the one or more discrepancies. An example of tampering identification includes, but is not limited to, creating an integrity violation log entry, updating a security status field in a ledger record, or setting a tamper flag within a verification routine.

At step 332, processing the new prompt upon successful verification of the block-chained conversation history to determine whether the new prompt comprises a policy violation and replacing the new prompt with the null value when the new prompt comprises the policy violation. An example of policy evaluation includes, but is not limited to, rule-based filtering, keyword matching, anomaly detection, or classification using a trained model.

At step 334, generating a response corresponding to the new prompt using the artificial intelligence model. An example of artificial intelligence model includes, but is not limited to, a transformer-based language model, a neural network inference engine, or a domain-specific conversational.

At step 336, computing the message hash corresponding to a new conversation entry and the chain hash corresponding to the new conversation entry. An example of hash computation includes, but is not limited to, executing a keyed-hash message authentication code, performing a salted SHA-based digest, or applying a keyed Blake2 algorithm.

At step 338, updating the block-chained conversation history by appending the new conversation entry to the plurality of conversation entries, wherein the new conversation entry comprises the new prompt, the response, the message hash, and the chain hash. Update operation may involve committing the new conversation entry to a database, indexing the new conversation entry within the plurality of conversation entries, and linking the chain hash corresponding to the new conversation entry to a preceding chain hash.

At step 340, generating a compressed conversation summary based on at least one portion of the block-chained conversation history. At-least one portion of the block-chained conversation history may be determined based on context length limits, storage optimization policies, or processing constraints. Compression may involve semantic extraction, redundancy removal, and contextual abstraction performed by a processing subsystem executing on a server.

At step 342, recomputing the message hash corresponding to the compressed conversation summary and the chain hash corresponding to the compressed conversation summary to preserve integrity of the block-chained conversation history. An example of re-computation includes, but is not limited to, executing a keyed digest algorithm, recalculating a hash pointer in a ledger record, or updating a chained data structure.

The method 300 ends at step 342.

Various embodiments of the system and method to detect and prevent tampering in user-artificial intelligence conversations described above enable various advantages. The system 100 ensures prevention of unauthorized modification of block-chained conversation history through use of a proof-of-knowledge hash function incorporating a high-entropy server-side secret, thereby restricting valid message hash and chain hash generation exclusively to processing subsystem 106. The system 100 enables deterministic detection of tampering through re-computation and comparison of cryptographic values prior to processing a new prompt, thereby preventing propagation of corrupted conversation entries. The system 100 preserves structural continuity of the plurality of conversation entries through controlled null substitution, conditional chain linking, and preservation of a final chain hash during truncation. The system 100 supports efficient scalability through implementation of a sliding window mechanism and compression module 130 while maintaining cryptographic anchoring of compressed conversation summary. The system 100 further provides deployment flexibility through compatibility with stateful service architecture and stateless service architecture without compromising integrity of block-chained conversation history. Collectively, the system 100 enhances security, tamper resistance, policy enforcement, auditability, scalability, and operational reliability of user-artificial intelligence conversations executed across server 108 and network 110.

The techniques described in this disclosure may be implemented, at least in part, in hardware, software, firmware, or any combination thereof. For example, various aspects of the described techniques may be implemented within one or more processors, including one or more microprocessors, digital signal processors (DSPs), application-specific integrated circuits (ASICs), field-programmable gate arrays (FPGAs), or any other equivalent integrated or discrete logic circuitry, as well as any combinations of such components. The term “processor” or “processing subsystem” may generally refer to any of the foregoing logic circuitry, alone or in combination with other logic circuitry, or any other equivalent circuitry. A control unit including hardware may also perform one or more of the techniques of this disclosure.

Such hardware, software, and firmware may be implemented within the same device or within separate devices to support the various techniques described in this disclosure. In addition, any of the described units, modules, or components may be implemented together or separately as discrete but interoperable logic devices. Depiction of different features as modules or units is intended to highlight different functional aspects and does not necessarily imply that such modules or units must be realized by separate hardware, firmware, or software components. Rather, functionality associated with one or more modules or units may be performed by separate hardware, firmware, or software components, or integrated within common or separate hardware, firmware, or software components.

It will be understood by those skilled in the art that the foregoing general description and the following detailed description are exemplary and explanatory of the disclosure and are not intended to be restrictive thereof.

While specific language has been used to describe the disclosure, any limitations arising on account of the same are not intended. As would be apparent to a person skilled in the art, various working modifications may be made to the method in order to implement the inventive concept as taught herein.

The figures and the foregoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, the order of processes described herein may be changed and are not limited to the manner described herein. Moreover, the actions of any flow diagram need not be implemented in the order shown; nor do all of the acts need to be necessarily performed. Also, those acts that are not dependent on other acts may be performed in parallel with the other acts. The scope of embodiments is by no means limited by these specific examples.

We claim:

1. A system to detect and prevent tampering in user-artificial intelligence conversations, comprising:
a hardware processor; and
a memory coupled to the hardware processor, wherein the memory comprises a set of program instructions in the form of a processing subsystem, configured to be executed by the hardware processor, wherein the processing subsystem is hosted on a server and configured to execute on a network to control bidirectional communications among a plurality of modules comprising:
a guardrail module configured to:
receive a prompt to initiate a user-artificial intelligence conversation from the user operating a user device and determine whether the prompt comprises a policy violation;
replace the prompt with a null value upon determination of the policy violation;
a hash module operatively coupled to the guardrail module, wherein the hash module comprises a proof-of-knowledge hash function, wherein the hash module is configured to:
generate a high-entropy server-side secret using a cryptographically secure random number generator and store the high-entropy server-side secret in a database;
apply a secure hash function salted with the server-side secret to generate a message hash and a chain hash corresponding to each of a plurality of conversation entries of a block-chained conversation history;
assign a predefined zero value as the message hash when a prompt corresponding to a conversation entry of the plurality of conversation entries is the null value;
a blockchain management module operatively coupled to the hash module, wherein the blockchain management module is configured to:
record the plurality of conversation entries on a blockchain to generate the block-chained conversation history, wherein each of the plurality of conversation entries comprises the prompt corresponding to the conversation entry, a response generated by an artificial intelligence model corresponding to the conversation entry, the message hash corresponding to the conversation entry, and the chain hash corresponding to the conversation entry;
append a new conversation entry corresponding to a new prompt to the plurality of conversation entries of the block-chained conversation history based on the message hash and the chain hash corresponding to the new conversation entry;
maintain continuity of the block-chained conversation history by linking the chain hash corresponding to each conversation entry of the plurality of conversation entries to a preceding chain hash corresponding to a prior conversation entry of the plurality of conversation entries;
truncate the block-chained conversation history backwards in time using a sliding window mechanism specifically tailored for blockchain-based artificial intelligence model conversation history;
remove one or more prompts that were replaced with the null value and store the one or more prompts as the null value within the plurality of conversation entries; and
treat the new prompt as a continuation of the block-chained conversation history from a point at which the block-chained conversation history was previously truncated based on an edit made to an earlier prompt;
a verification module operatively coupled to the blockchain management module and the hash module, wherein the verification module is configured to:
verify integrity of the block-chained conversation history prior to processing the new prompt by recomputing the message hash corresponding to each conversation entry of the plurality of conversation entries and the chain hash corresponding to each conversation entry of the plurality of conversation entries;
verify correctness of the chain hash corresponding to each conversation entry of the plurality of conversation entries to ensure continuity of the block-chained conversation history remains unbroken;
detect one or more discrepancies between a recomputed message hash corresponding to a conversation entry of the plurality of conversation entries or a recomputed chain hash corresponding to a conversation entry of the plurality of conversation entries and a corresponding stored message hash or a corresponding stored chain hash of the block-chained conversation history; and
identify a tampering of the block-chained conversation history upon detection of the one or more discrepancies;
an update module operatively coupled to the guardrail module, the verification module, and the blockchain management module, wherein the update module is configured to:
process the new prompt upon successful verification of the block-chained conversation history to determine whether the new prompt comprises a policy violation and replace the new prompt with the null value when the new prompt comprises the policy violation;
generate a response corresponding to the new prompt using the artificial intelligence model;
compute the message hash corresponding to a new conversation entry and the chain hash corresponding to the new conversation entry; and
update the block-chained conversation history by appending the new conversation entry to the plurality of conversation entries, wherein the new conversation entry comprising the new prompt, the response, the message hash, and the chain hash; and
a compression module operatively coupled to the blockchain management module, wherein the compression module is configured to:
generate a compressed conversation summary based on at least one portion of the block-chained conversation history; and
recompute the message hash corresponding to the compressed conversation summary and the chain hash to preserve an integrity of the block-chained conversation history.

2. The system as claimed in claim 1, wherein the verification module is further configured to block processing of the new prompt when the verification module determines that the block-chained conversation history has been tampered with.

3. The system as claimed in claim 1, wherein the verification module is further configured to generate an alert notification when the verification module determines that the block-chained conversation history has been tampered with.

4. The system as claimed in claim 1, wherein the sliding window mechanism is configured to preserve at least one final chain hash corresponding to a most recent conversation entry of the plurality of conversation entries after truncation of the block-chained conversation history.

5. The system as claimed in claim 1, wherein the blockchain management module is configured to skip a conversation entry of the plurality of conversation entries having the predefined zero value as the message hash when computing a subsequent chain hash corresponding to another conversation entry of the plurality of conversation entries.

6. The system as claimed in claim 1, wherein the compression module is configured to transmit at least one portion of the block-chained conversation history to the artificial intelligence model for summarization prior to recomputing the message hash corresponding to the compressed conversation summary and the chain hash corresponding to the compressed conversation summary.

7. The system as claimed in claim 1, wherein the processing subsystem is configured to operate in at least one of a stateful service architecture and a stateless service architecture while maintaining integrity of the block-chained conversation history.

8. A method to detect and prevent tampering in user-artificial intelligence conversations, comprising:
receiving, a prompt to initiate a user-artificial intelligence conversation from a user and determine whether the prompt comprises a policy violation;
replacing the prompt with a null value upon determination of the policy violation;
generating a high-entropy server-side secret using a cryptographically secure random number generator and storing the high-entropy server-side secret in a database;
applying a secure hash function salted with the server-side secret to generate a message hash and a chain hash corresponding to each of a plurality of conversation entries of a block-chained conversation history;
assigning a predefined zero value as the message hash when a prompt corresponding to a conversation entry of the plurality of conversation entries is the null value;
recording the plurality of conversation entries on a blockchain to generate the block-chained conversation history, wherein each of the plurality of conversation entries comprises the prompt corresponding to the conversation entry, a response generated by an artificial intelligence model corresponding to the conversation entry, the message hash corresponding to the conversation entry, and the chain hash corresponding to the conversation entry;
appending a new conversation entry corresponding to a new prompt to the plurality of conversation entries of the block-chained conversation history based on the message hash and the chain hash corresponding to the new conversation entry;
maintaining continuity of the block-chained conversation history by linking the chain hash corresponding to each conversation entry of the plurality of conversation entries to a preceding chain hash corresponding to a prior conversation entry of the plurality of conversation entries;
truncating the block-chained conversation history backwards in time using a sliding window mechanism specifically tailored for blockchain-based artificial intelligence model conversation history;
removing one or more prompts that were replaced with the null value and storing the one or more prompts as the null value within the plurality of conversation entries;
treating the new prompt as a continuation of the block-chained conversation history from a point at which the block-chained conversation history was previously truncated based on an edit made to an earlier prompt;
verifying integrity of the block-chained conversation history prior to processing the new prompt by recomputing the message hash corresponding to each conversation entry of the plurality of conversation entries and the chain hash corresponding to each conversation entry of the plurality of conversation entries;
verifying correctness of the chain hash corresponding to each conversation entry of the plurality of conversation entries to ensure continuity of the block-chained conversation history remains unbroken;
detecting one or more discrepancies between a recomputed message hash corresponding to a conversation entry of the plurality of conversation entries or a recomputed chain hash corresponding to a conversation entry of the plurality of conversation entries and a corresponding stored message hash or a corresponding stored chain hash of the block-chained conversation history;
identifying a tampering of the block-chained conversation history upon detection of the one or more discrepancies;
processing the new prompt upon successful verification of the block-chained conversation history to determine whether the new prompt comprises a policy violation and replacing the new prompt with the null value when the new prompt comprises the policy violation;
generating a response corresponding to the new prompt using the artificial intelligence model;
computing the message hash corresponding to a new conversation entry and the chain hash corresponding to the new conversation entry;
updating the block-chained conversation history by appending the new conversation entry to the plurality of conversation entries, wherein the new conversation entry comprises the new prompt, the response, the message hash, and the chain hash;
generating a compressed conversation summary based on at least one portion of the block-chained conversation history; and
recomputing the message hash corresponding to the compressed conversation summary and the chain hash corresponding to the compressed conversation summary to preserve integrity of the block-chained conversation history.

9. A non-transitory computer-readable medium storing a computer program that, when executed by a processor, causes the processor to perform a method to detect and prevent tampering in user-artificial intelligence conversations, comprising:
receiving a plurality of raw delimited text files from one or more unstructured sources from a user operating a user device;
receiving, a prompt to initiate a user-artificial intelligence conversation from a user and determine whether the prompt comprises a policy violation;
replacing the prompt with a null value upon determination of the policy violation;
generating a high-entropy server-side secret using a cryptographically secure random number generator and storing the high-entropy server-side secret in a database;
applying a secure hash function salted with the server-side secret to generate a message hash and a chain hash corresponding to each of a plurality of conversation entries of a block-chained conversation history;
assigning a predefined zero value as the message hash when a prompt corresponding to a conversation entry of the plurality of conversation entries is the null value;
recording the plurality of conversation entries on a blockchain to generate the block-chained conversation history, wherein each of the plurality of conversation entries comprises the prompt corresponding to the conversation entry, a response generated by an artificial intelligence model corresponding to the conversation entry, the message hash corresponding to the conversation entry, and the chain hash corresponding to the conversation entry;
appending a new conversation entry corresponding to a new prompt to the plurality of conversation entries of the block-chained conversation history based on the message hash and the chain hash corresponding to the new conversation entry;
maintaining continuity of the block-chained conversation history by linking the chain hash corresponding to each conversation entry of the plurality of conversation entries to a preceding chain hash corresponding to a prior conversation entry of the plurality of conversation entries;
truncating the block-chained conversation history backwards in time using a sliding window mechanism specifically tailored for blockchain-based artificial intelligence model conversation history;
removing one or more prompts that were replaced with the null value and storing the one or more prompts as the null value within the plurality of conversation entries;
treating the new prompt as a continuation of the block-chained conversation history from a point at which the block-chained conversation history was previously truncated based on an edit made to an earlier prompt;
verifying integrity of the block-chained conversation history prior to processing the new prompt by recomputing the message hash corresponding to each conversation entry of the plurality of conversation entries and the chain hash corresponding to each conversation entry of the plurality of conversation entries;
verifying correctness of the chain hash corresponding to each conversation entry of the plurality of conversation entries to ensure continuity of the block-chained conversation history remains unbroken;
detecting one or more discrepancies between a recomputed message hash corresponding to a conversation entry of the plurality of conversation entries or a recomputed chain hash corresponding to a conversation entry of the plurality of conversation entries and a corresponding stored message hash or a corresponding stored chain hash of the block-chained conversation history;
identifying a tampering of the block-chained conversation history upon detection of the one or more discrepancies;
processing the new prompt upon successful verification of the block-chained conversation history to determine whether the new prompt comprises a policy violation and replacing the new prompt with the null value when the new prompt comprises the policy violation;
generating a response corresponding to the new prompt using the artificial intelligence model;
computing the message hash corresponding to a new conversation entry and the chain hash corresponding to the new conversation entry;
updating the block-chained conversation history by appending the new conversation entry to the plurality of conversation entries, wherein the new conversation entry comprises the new prompt, the response, the message hash, and the chain hash;
generating a compressed conversation summary based on at least one portion of the block-chained conversation history; and
recomputing the message hash corresponding to the compressed conversation summary and the chain hash corresponding to the compressed conversation summary to preserve integrity of the block-chained conversation history.
